(19) United States
(12) Patent Application Publication
(10) Pub. No.: US 2022/0015494 A1
(43) Pub. Date: Jan. 20, 2022

(54) FOOTWEAR MANUFACTURING PROCESS

(71) Applicant: Lana S. Krause, Leawood, KS (US)

(72) Inventor: Lana S. Krause, Leawood, KS (US)

(21) Appl. No.: 16/933,143

(22) Filed: Jul. 20, 2020

(51) Int. Cl. A43B 1/12; A43B 13/04; A43D 29/00

(52) U.S. Cl. CPC A43B 1/12; A43D 29/00; A43B 13/04

(57) ABSTRACT

A method of reclaiming used tennis balls and transforming the material reclaimed from the tennis balls into soles for footwear. This multi-step process requires acquiring used tennis balls, grinding the tennis balls into ground rubber bits (usable elements) and tennis ball “fuzz” (unusable elements). The rubber and fuzz are passed through a screen which allows the rubber bits to exit the screen but retains the fuzz. The rubber is then mixed with an H₂O and Polyurethane mixture to form a rubber mixture. This mixture is then pressed into a shape using a mold, cured, and then used to manufacture footwear.

### BACKGROUND OF THE INVENTION

### 1. Field of the Invention

The present invention relates generally to a footwear manufacturing process and method thereof, and more specifically to a method of reclaiming and using tennis balls for manufacturing the sole of a shoe or other piece of footwear.

### 2. Description of the Related Art

Shoes often have soles made of rubber or other flexible yet resilient material. This typically requires soles to be formed out of new sources of rubber or other manufacturing materials devoted purely for that purpose.

As tennis balls are used, they quickly lose their “bounce,” and wear out. However, presently there is no good use for used or reclaimed tennis balls, and they mostly wind up in the garbage, taking up space in landfills.

Heretofore there has not been available a system or method for footwear manufacturing with the advantages and features of the present invention.

### BRIEF SUMMARY OF THE INVENTION

The present invention generally provides a method of reclaiming used tennis balls and transforming the material reclaimed from the tennis balls into soles for footwear. This multi-step process requires acquiring used tennis balls, grinding the tennis balls into ground rubber bits (usable elements) and tennis ball “fuzz” (unusable elements). The rubber and fuzz are passed through a screen which allows the rubber bits to exit the screen but retains the fuzz. The rubber is then mixed with an H₂O and Polyurethane mixture to form a rubber mixture. This mixture is the molded in a mold, cured, and then removed from the mold in the shoe sole shape and size which can be used to manufacture footwear.

### BRIEF DESCRIPTION OF THE DRAWINGS

The drawings constitute a part of this specification and include exemplary embodiments of the present invention illustrating various objects and features thereof.

FIG. 1 is a three-dimensional isometric view of a plurality of tennis balls used as a construction component in association with a preferred embodiment of the present invention.

FIG. 2 is a three-dimensional isometric view showing tennis balls of FIG. 1 being ground into usable materials and unusable materials.

FIG. 3 is a three-dimensional isometric view of a rotary machine with teeth showing the usable material of FIG. 2 being further refined.

FIG. 4 is a three-dimensional isometric view showing the usable material of FIG. 3 being separated out from unusable material.

FIG. 5 is a three-dimensional isometric view of a mold element.

FIG. 6 is a three-dimensional isometric view showing combining of components to form a rubber, water, and polyurethane mixture.

FIG. 7 is a three-dimensional isometric view of a final resulting shoe sole.

FIG. 8 is a flow chart diagraming the steps in practicing the present invention.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment Footwear Manufacturing Process 2

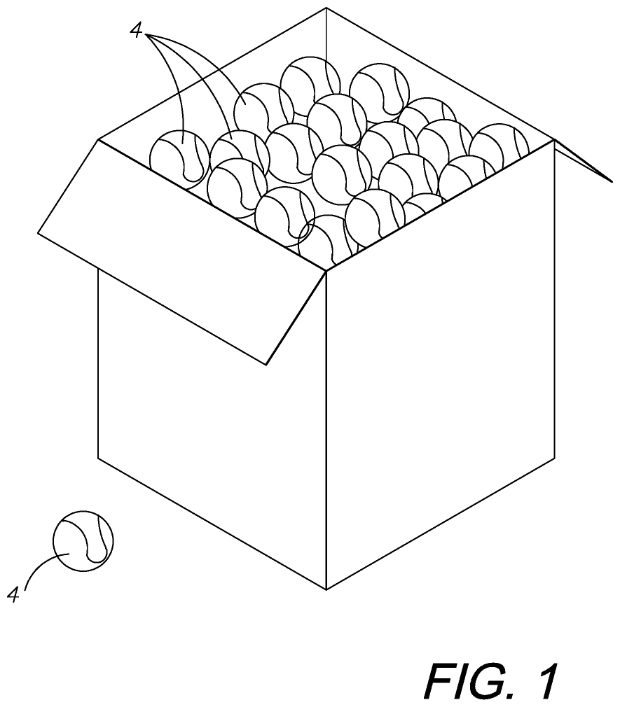

Referring to the figures in detail, FIGS. 1-6 show a step-by-step process of how the present invention operates, whereby a footwear element 38 is generated out of used tennis balls 4.

FIG. 1 shows the collection of used tennis balls 4, such as from tennis clubs, teams, and individuals. This process could include a donation station or other suitable means for getting the used tennis balls from their original owners who have no further use for them to the manufacturer.

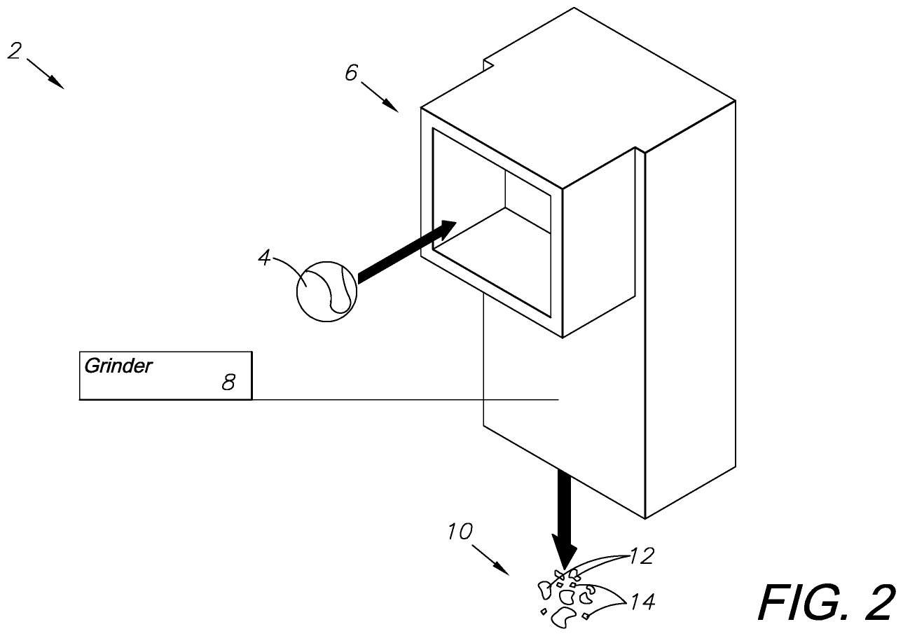

FIG. 2 shows the tennis balls 4 being placed into a plastic granulator 6 which includes a grinder 8 which grinds the balls into a ground mass 10 including tiny usable pieces 14 and unusable tennis “fuzz” 12.

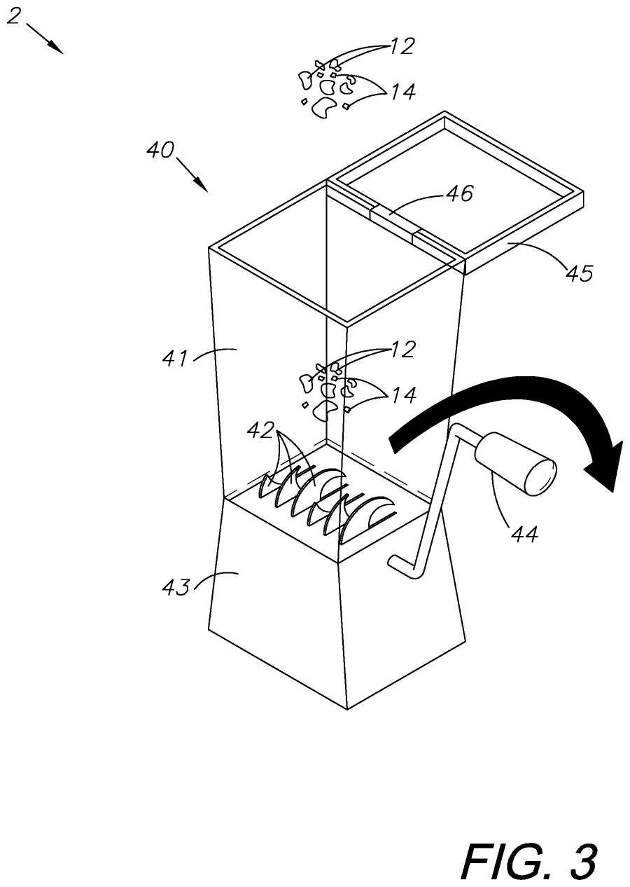

FIG. 3 shows a rotary machine 40 which has a container 41 for receiving the tiny usable pieces 14 and unusable fuzz 12. The teeth 42 remove the fuzz 12 from the rubber usable pieces 14 if they are still adhered to them. A motor or rotor is contained within a base 43. The teeth 42 may be activated by a motor or a rotatable handle 44. A lid 45 hinged to the container 41 by a hinge 46 can be included to prevent material from escaping the container 41.

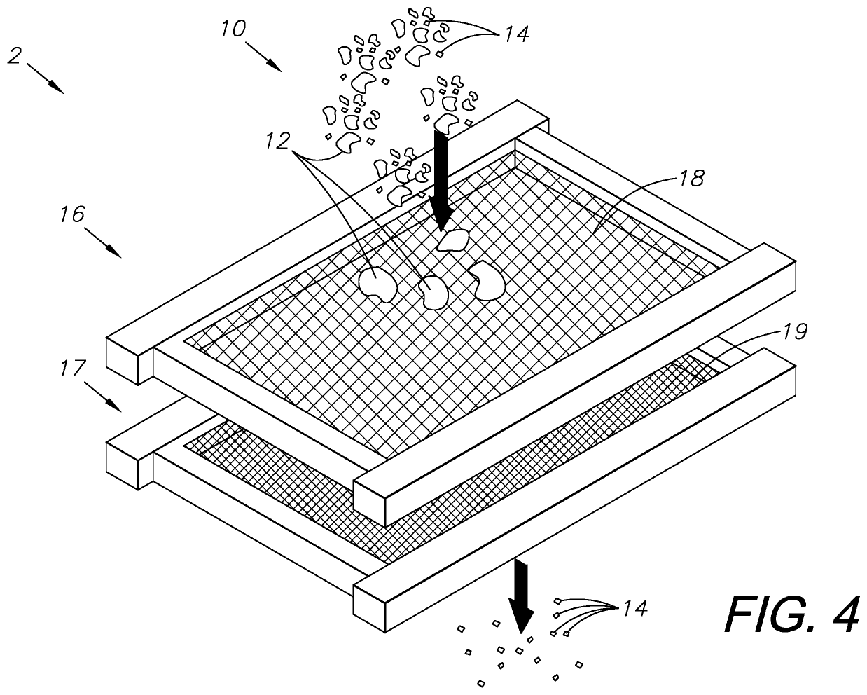

FIG. 4 shows the results of the grinding process, whereby the ground mass 10 passes through a first screen 16 with ¼″ holes 18 and a second screen 17 with ⅛″ holes 19. These sizes can be adjusted as determined most efficient. More screens could also be used. This step is used to separate the rubber elements 14 from the felt “fuzz” 12 which covers the rubber ball. A portion of the fuzz 12 may be added back into the mixture (approximately 0.5 oz.) as shown in FIG. 4. The screen could be constructed from ⅛ inch and/or ¼ inch chicken wire attached to a wooden frame. Other various sizes of chicken wire or screen material could be used as appropriate.

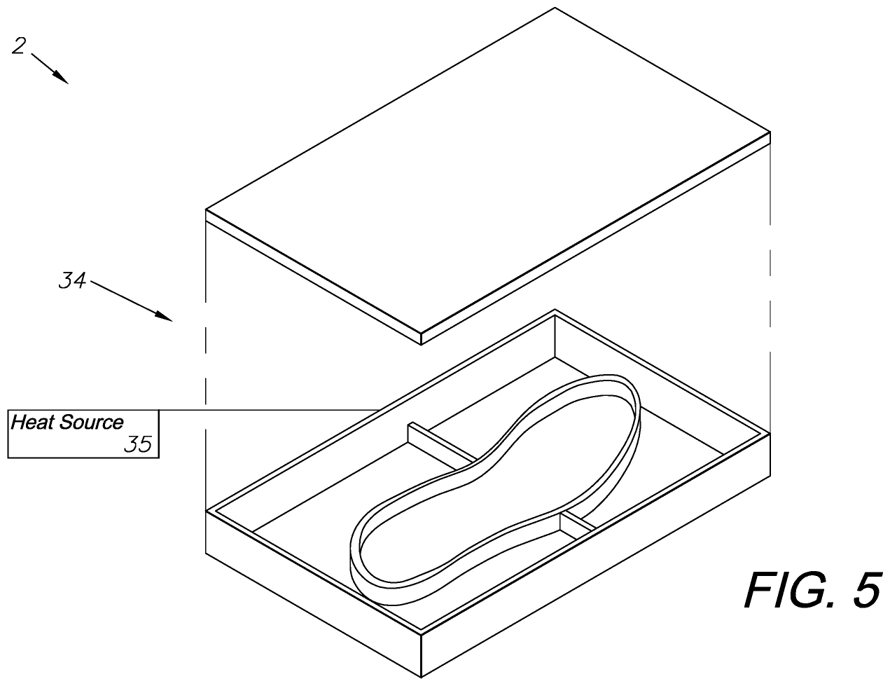

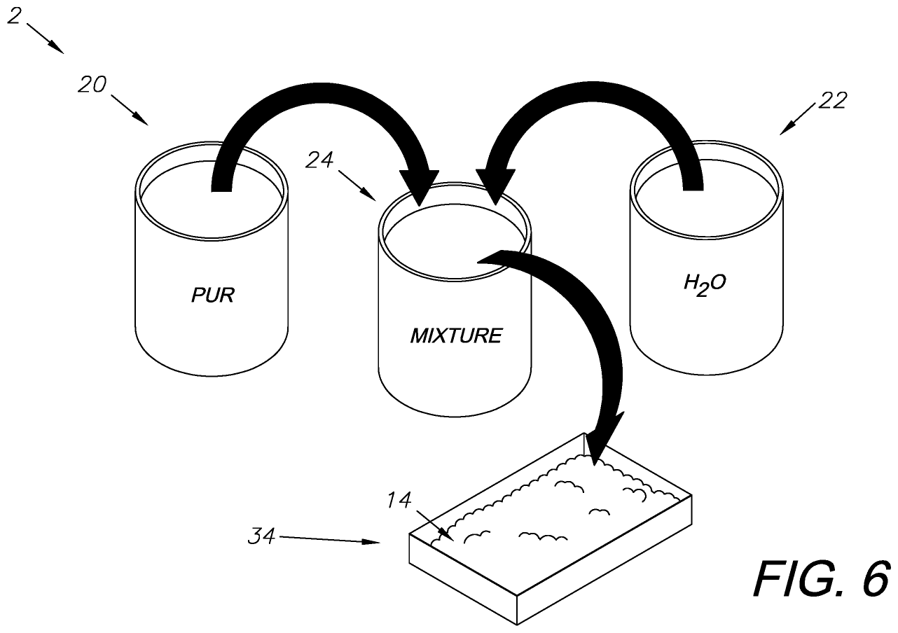

FIG. 5 shows a mold element 34 which can be used to form a shoe sole shape. The mold may be an injection mold, an extrusion mold, or any other type of mold including a simple shape mold. A heat source 35, such as a simple electrical current to generate heat, could be applied to the mold element 34 to increase the curing process of the final shoe sole 38. FIG. 6 shows the creation of a rubber mixture which includes the rubber crumb bits/granules 14 from FIG. 3, along with a combination of water 22 and polyurethane 20. The ratio here is 5.2 oz. of polyurethane to 0.6 oz. of water, and adding that mixture to one pound (1 lb.) of rubber bits. The resultant mixture is labeled 24. The mixture 24 is poured or injected into the mold 34 and then cured. A press or other device may need to be used, depending on the mold, to compress the mixture 24 into the mold 34.

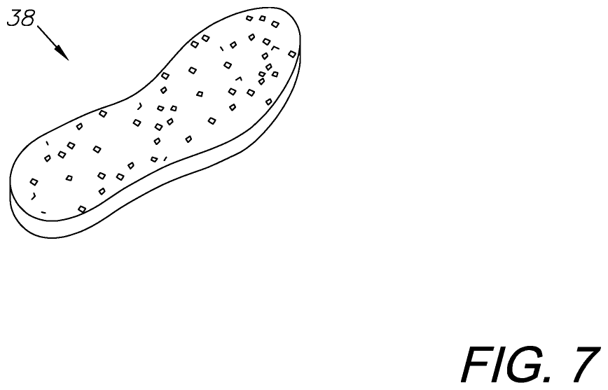

FIG. 7 shows a shoe sole 38 removed from the mold and resulting from the rubber mixture, which can then be placed into a piece of footwear. Any unused portion of the rubber mixture can be placed back into the granulator, as shown in FIG. 2, to be repurposed and reused for additional soles. Alternatively, there may be no need for this step in an ideal embodiment where plates are incorporated into the hydraulic press step which creates soles with minimal excess product.

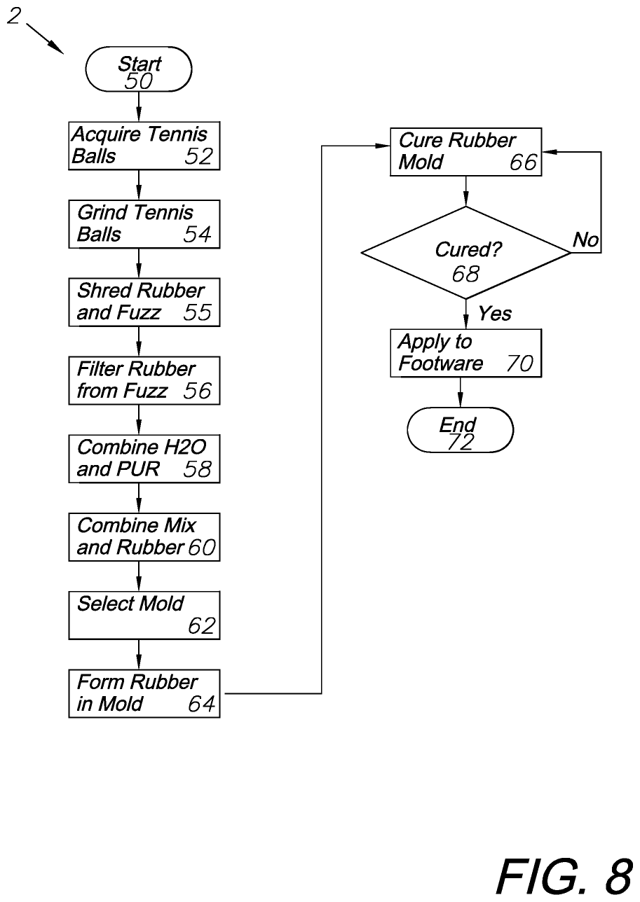

FIG. 8 runs through these steps in a flowchart diagramming out the method of steps required. As above, the process starts at 50, and the used tennis balls are acquired at 52. These are ground in the plastic granulator at 54, and further refined in the rotary machine at 55 and filtered into the usable rubber pieces at 56.

The H₂O and Polyurethane are mixed at 58 and combined with the rubber pieces at 60. A mold is selected at 62, and the rubber, H₂O, and polyurethane mixture is formed within the mold at 64. The resulting rubber mold is cured for three hours at 66. Heat can be applied to the curing process via a heating element 35 as shown in FIG. 5 to speed up curing time. The user will check at 68 whether the sheet is fully cured—if not, curing continues. If curing is achieved at 68, it results in in a shoe sole which is applied to footwear at 70. The process then ends at 72.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A method of manufacturing a shoe sole, the method comprising the steps:
acquiring a plurality of tennis balls;
grinding the tennis balls in a granulator, thereby generating felt fuzz and rubber granules;
passing said felt fuzz and rubber granules through a rotary machine comprising teeth which remove said felt fuzz from said rubber granules;
passing said felt fuzz and rubber granules through at least one screen, thereby separating said rubber granules from said felt fuzz;
combining water and polyurethane, resulting in a water and polyurethane mixture;
combining said water and polyurethane mixture with said rubber granules;
mixing said rubber granules and said water and polyurethane mixture into a rubber mixture;
placing said rubber mixture into a mold;
forming a footwear sole with said mold;
curing said footwear sole; and
applying said sole to a piece of footwear.

2. The method of claim 1, wherein said water and polyurethane mixture comprises is 5.2 oz. of polyurethane and 0.6 oz. of water.

3. The method of claim 1, wherein said rubber mixture comprises 5.2 oz. of polyurethane, 0.6 oz. of water, and one pound of rubber granules.

4. The method of claim 3, wherein said rubber mixture further comprises 0.5 oz. said felt fuzz.

5. The method of claim 1, further comprising the steps:
wherein said at least one screen comprises a first screen and a second screen, said first screen having a plurality of holes at a first size, and said second screen having a plurality of holes at a second size, wherein said second size is smaller than said first size; and
passing said felt fuzz and rubber granules first through said first screen and then through said second screen.

6. The method of claim 5, wherein said first size comprises ¼″ holes and said second size comprises ⅛″ holes.

7. The method of claim 1, further comprising:
heating said mold with a heat source; and
increasing the curing of said footwear sole via said heat source heating said mold.
